(19) United States
(12) Patent Application Publication
(10) Pub. No.: US 2023/0332460 A1
(43) Pub. Date: Oct. 19, 2023

(54) AN INSULATED DOOR LEAF FOR A GATE, A GATE COMPRISING AN INSULATED DOOR LEAF, AND USE OF AN INSULATING BAFFLE IN A DOOR LEAF

(71) Applicant: DAN-doors A/S, Skanderborg (DK)

(72) Inventor: Kim Jensen, Frederiksberg C (DK)

(21) Appl. No.: 18/011,478

(22) PCT Filed: Jun. 24, 2021
(86) PCT No.: PCT/DK2021/050208

§ 371 Date: Dec. 19, 2022

(30) Foreign Application Priority Data
Jun. 24, 2020 (DK) PA 2020 70412

(51) Int. Cl. E06B 3/70; E06B 3/80

(52) U.S. Cl. CPC E06B 3/7005; E06B 3/80; E06B 2003/7023

(57) ABSTRACT

An insulated door leaf (10) for a gate (100), the door leaf (10) comprising—insulating baffles (20) comprising a bottom baffle (22) and one or more intermediate baffles (24), the baffles (20) comprise baffle channels forming one or more common cord channels (40) from the bottom baffle (22) through the one or more intermediate baffles (24), —one or more cords (50) extending from the bottom baffle (22) through the one or more common cord channels (40).

### FIELD OF THE INVENTION

The present invention relates to an insulated door leaf capable of being used in different gates, such as a roller door or sliding doors or sectional doors to be used in storag-es which may have a room temperature down to −60 degrees Celsius.

The present invention relates to a gate comprising an insulated door leaf, wherein the door leaf is designed to enable high-speed movement.

### BACKGROUND OF THE INVENTION

Insulated gates between a cold storage room or area and a hot storage room or area are a growing market due to a higher demand for energy efficiency.

The skilled person would understand that the hot storage room is a storage having a temperature higher than the cold storage room, i.e. if the cold storage room has a temperature of −18 degrees Celsius then the hot storage room may be a storage having a temperature of −15 degrees Celsius or 20 Celsius or any other temperature higher than the cold storage room.

The cold storage room may be a freezing chamber.

The temperature in the freezing chamber or cold storage room will typically be between −60 to 0 degrees Celsius.

The efficiency of the insulating gates is determined by the insulating property of the door leaf, and this can simply be increased by increasing the amount of insulating material. Increasing the amount of insulating material will however decrease the opening and closing speed of the doors and gates, and/or require a more complex and/or heavi-er gate operating mechanism.

The efficiency of the insulating gates is also determined by the opening and closing speed of the gates, i.e. the operation speed. Such an insulating gate may open and close a thousand times or more on a single day, and thus if the operation speed is de-creased then the efficiency of the insulating gates decrease by a large factor as hotter air is transferred from the hot storage room to the cold storage room.

Should the door leaf be damaged then the entire door leaf will often need replacement if a drop in efficiency cannot be accepted, because the damage often will create a cold bridge.

Thus, there is a need for a door leaf which can be repaired and thereby decreasing operation costs.

WO2017063656 describes a solution to a roller gate, wherein the door leaf comprises inwardly inclined edges to enable the door leaf to be rolled around the roller. The con-sequence of this is that the door leaf thickness decreases at various points causing a drop in the efficiency of the insulating gate.

Furthermore, this also means that the door leaf will not be used in a roller gate, wherein the door leaf is moved directly upwardly or from side to side, because the inclined edges would reduce the efficiency. However, removal of the inclined edge would cause the door leaf to be incompatible with a roller gate.

Thus, there is a need for a universal door leaf which can be used in different types of roller gates without modifications.

### OBJECT OF THE INVENTION

It is an object of the invention to provide an insulated door leaf and a gate comprising an insulated door leaf which overcomes the limitation of the prior art.

### DESCRIPTION OF THE INVENTION

An object of the invention is achieved by an insulated door leaf for a high speed gate. The door leaf comprises insulating baffles. The insulating baffles may comprise a bottom baffle and one or more intermediate baffles. The baffles may comprise baffle channels forming one or more common cord channels from the bottom baffle through the one or more intermediate baffles.

The door leaf may further comprise one or more cords extending from the bottom baffle through the one or more common cord channels.

Thereby, a door leaf is provided which can be moved from side to side and/or up and down.

The baffles of the door leaf may further be stacked during transportation by increasing the length of the cord between the bottom baffle and an uppermost intermediate baffle, thereby allowing the door leaf to bend. An example is shown in FIG. 2B.

The baffles are made of an insulating material such as but not limited to Neoprene®, polystyrene or a similar foamed insulation material. The skilled person would know other materials to choose in order to get a sufficient insulation effect.

The thickness of the baffles may be 50-300 mm, or 100-250 mm or 160-200 mm.

Thereby, the door leaf may be used in storage rooms having a temperature of −60 degrees Celsius.

The skilled person would know that a baffle thickness of 100 mm using known material has an insulation effect of about 0.39 W/(m² K). The skilled person would be able to use this knowledge to modify the thickness depending on whether an increase or a decrease in thickness is needed for a certain task.

The baffles may have a length of 1-8 m, or 2-6 m, or 3-4 m. However, the baffles may be longer or shorter depending on the gate design.

The height of the baffles may be 40-120 cm, or 60-100 cm, or 75-90 cm, or 80 cm.

The baffles may be produced on-site due to the simplicity of the baffles as the baffles are just cut at lengths corresponding to the width of the gate.

The baffles comprise baffle channels forming one or more common cord channels from the bottom baffle through the one or more intermediate baffles. Thus, each baffle comprises one or more throughgoing baffle channels and one or more common cord channels are then formed when the baffles are aligned.

The one or more throughgoing baffle channels may be perpendicular to a longitudinal direction of the baffles.

The one or more cords extending from the bottom baffle through the one or more common cord channels ensure that the insulated door is formed using simple means.

The skilled person would know how to secure the one or more cords to the bottom baffle. The bottom baffle may comprise a transversal bar to which the one or more cords can be attached.

One or more knots or other tightening means may be used after the upper most intermediate baffle to force baffles together, such that the door leaf is tight, such as air tight, to improve insulation.

The door leaf is not to be pulled by the cords when in use in a gate. The purpose of the cords is a way to allow the door leaf to be folded during storage or transportation as cord slack can be introduced by adding additional lengths of cords between the bottom baffle and the tightening means or one or more knots.

The baffles can be further interconnected however they can be seen as separate units. This enables an easier repair of the door leaf as any damaged baffle can be replaced by untightening the knot or tightening means and replacing the damaged baffle.

One or more of the baffles may comprise insulating material inserted into a sleeve made of a flexible artificial web such as reinforced tarpaulin web of PVC or polyester or other suitable materials known to the skilled person.

The sleeve material enables the baffles and thus the door leaf to have a flush surface.

The door leaf may comprise baffles wherein the baffles have different heights. The difference in height is especially useful when the door leaf is used in a roller gate as the heights are adjusted to the increasing effective diameter of the roller gate.

The cords together with the bottom baffle enable the door leaf to be used in sliding doors or sectional doors at high speed since the separate baffles will move as a single unit.

In an aspect of the invention, at least two baffles may be separate units only interconnected by the one or more cords. Thereby, at least two baffles can be replaced or repaired, if damaged, without changing the entire door leaf.

In an aspect of the invention, the one or more intermediate baffles comprising a bottom face facing the bottom baffle and an opposite top face, the bottom face being concave and the top face being convex.

Tests show that the form of the intermediate baffles increases the tightness of the connection between the intermediate baffles as the curvature guides neighbouring baffles together.

In an embodiment, the bottom face is inwardly curved and the top face is outwardly curved.

The bottom baffle has a bottom baffle upper face facing the intermediate baffles, which upper face is convex for engaging a bottom face of a lowermost intermediate baffle.

The bottom baffle comprises a bottom baffle bottom face opposite to a bottom baffle upper face which is shaped to engage the floor surface or lower gate surface. The bottom baffle bottom face will typically be flat or planar to engage the plane floor surface. However, if the floor surface or lower gate surface have any other shape, then the bottom baffle bottom face will conform to said shape.

In an aspect of the invention, the one or more intermediate baffles are wrapped in a flexible web, wherein the flexible web does not conform to the bottom face, when the intermediate baffles are apart. This increases tightness of the connection between two intermediate baffles as the flexible web will be forced towards the upper part of another baffle.

The flexible artificial web may be reinforced tarpaulin web of PVC or polyester or any other flexible suitable material. The skilled person would know which material to choose depending on the task.

In an aspect of the invention, the insulated door leaf may comprise a biasing cassette, wherein the one or more intermediate baffles are positioned between the bottom baffle and biasing cassette. The biasing cassette may comprise one or more cassette channels in continuation of the one or more common cord channels.

The biasing cassette will make it easier to tighten the door leaf as the cords can be titled into a knot or be connected to tightening means on the other side of the biasing cassette relative to the baffles.

In an aspect of the invention, the biasing cassette having one or more friction elements for frictionally gripping the one or more cords.

Thereby, the door leaf can easily be tightened by pulling the cords, and the cords are then positioned at the friction elements.

In an aspect of the invention, the biasing cassette comprises a bottom part, a top part and one or more biasing elements extending between the bottom part and a top part forcing the top part and bottom part away from each other.

The bottom part, a top part and one or more biasing elements enable the door leaf to be used in a roller gate as the biasing cassette enables cord slack to be provided along the door leaf, such that the door leaf can be curved when moving the door leaf.

The amount of possible slack is determined by the biasing elements, and the skilled person would through tests be able to adjust the biasing element in order to achieve the best results.

The one or more biasing elements may be springs.

In an embodiment, the friction elements and the biasing elements are adjusted such that the friction elements are strong enough to allow the biasing elements to be pushed together with the cord sliding along the friction element.

In an embodiment, the baffles may have increasing height between the biasing cassette and the bottom baffle in order to adjust to an increase in the effective diameter of a roller gate. The skilled person would know that the effective diameter of the roller gate will increase as baffles are stacked upon each other during roll-up.

In an aspect of the invention, the bottom part and the top part have U-shaped cross-sections facing each other and one part being slideable within the other part.

The U-shaped cross-sections are a reliable solution to make the bottom part and the top part slideable within each other.

In an embodiment, the biasing elements form the cassette channel. It is expected that biasing elements forming cassette channels increase the stability of the biasing cassette.

In an aspect of the invention, the insulated door leaf comprises means for connecting with a drag leaf.

The means for connecting with a drag leaf may be a slit in which an end of the drag leaf is inserted.

The drag leaf enables a gate motor to pull the door leaf in a uniform matter.

An object of the invention is achieved by use of an insulating baffle with one or more through-going baffle channels adapted to form part of one or more common cord channels in an insulated door leaf.

The insulating baffle is designed such that it can be replaced if damaged without any need of modifying or adapting the rest of the insulating door leaf.

An object of the invention is achieved by a gate comprising an insulated door leaf as previously described.

A high-speed door typically has a speed of 1-4 m/s or 1.2-3 m/s or 1.4-2 m/s or 1.6 m/s.

However, the presented insulated door leaf is expected to work at even higher speeds than 4 m/s.

The skilled person would know that the gate comprises tracks along the side of the gate, wherein part of the door leaf is positioned within said tracks.

### DESCRIPTION OF THE DRAWING

Embodiments of the invention will be described in the figures, whereon:

FIG. 1 illustrates a door leaf;

FIG. 2 illustrates an intermediate baffle, a packed door leaf and a bottom baffle;

FIG. 3 illustrates a biasing cassette;

FIG. 4 illustrates a gate comprising a door leaf;

FIG. 5 illustrates a second embodiment of a biasing cassette;

FIG. 6 illustrates two different embodiments of a gate comprising a door leaf; and

FIG. 7 illustrates two different embodiments of a gate comprising a door leaf.

### DETAILED DESCRIPTION OF THE INVENTION

| Item | No |
|---|---|
| Door leaf | 10 |
| Baffles | 20 |
| Baffle channels | 21 |
| Bottom baffle | 22 |
| Transverse bar | 24 |
| Intermediate baffles | 30 |
| Bottom face | 32 |
| Top face | 34 |
| Common cord channels | 40 |
| Cords | 50 |
| Flexible web | 60 |
| Biasing cassette | 70 |
| Cassette channel | 72 |
| Friction element | 74 |
| Bottom part | 76 |
| Top part | 78 |
| Biasing element | 80 |
| Drag leaf engagement means | 82 |
| Drag leaf | 90 |
| Gate | 100 |

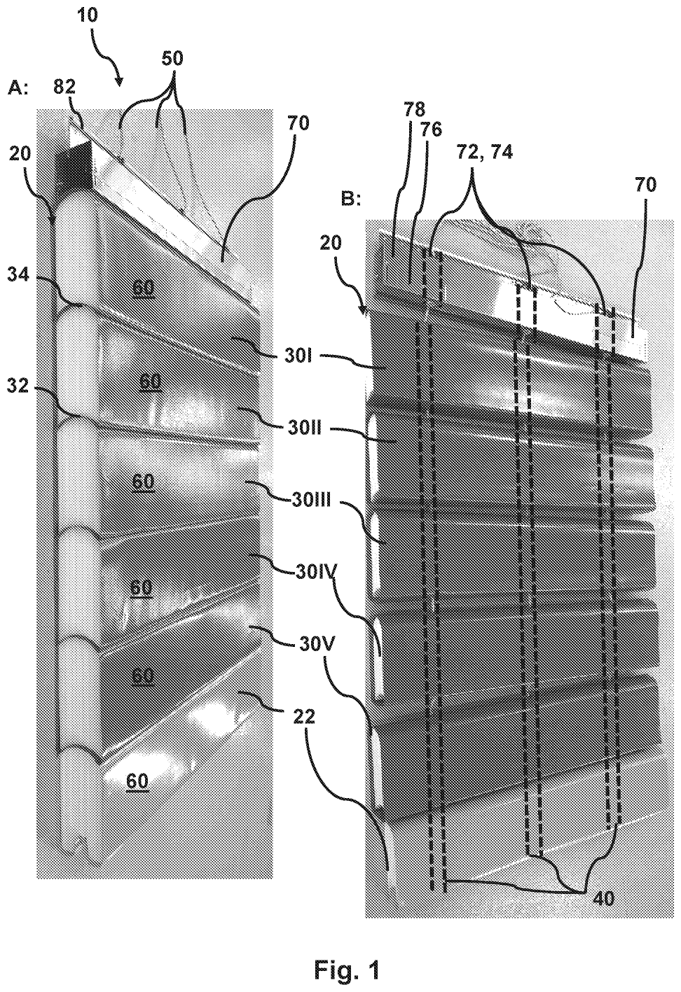

FIG. 1 illustrates a door leaf 10 in an insulating state (FIG. 1A) and in an open state (FIG. 1B).

The door leaf 10 comprises insulating baffles 20 such that the door leaf 10 becomes an insulating door leaf 10.

The baffles 20 comprise a bottom baffle 22 and five intermediate baffles 30I, . . . ,30V. There may be more or fewer intermediate baffles 30 depending on the needed height of the door leaf 10.

The skilled person would understand that baffles 20 is a genus for the species bottom baffle 22 and the intermediate baffle 30.

The baffles 20 comprise baffle channels 21 forming in this embodiment three common cord channels 40 (shown with dashed lines in FIG. 1B). The three common cord channels 40 extend from the bottom baffle 22 through the one or more intermediate baffles 30.

The door leaf 10 comprises three cords 50 extending from the bottom baffle 22 through the three common cord channels 40.

The skilled person would know that the invention is not limited to three cords or three common cord channels as it may depend on the size of the door leaf i.e. width, height and weight of the door leaf.

In this embodiment, each baffle 20 is a separate unit, which is only interconnected by the cords 70 to the other baffles 20, this is clearly shown in FIG. 1B.

Each of the baffles 20 are wrapped in a flexible web 60.

The intermediate baffles 30I, . . . , 30V comprise a bottom face 32 facing the bottom baffle 22 and an opposite top face 34. The bottom face 32 being concave and the top face 34 being convex.

The interaction between a concave bottom face and convex top face 34 ensures that the door leaf 10 becomes tightly closed.

The bottom baffle 20 comprises a concave bottom baffle top face facing a bottom face 34 of an intermediate baffle 30V such that the door leaf 10 becomes tightly closed.

The bottom baffle 20 comprises a bottom face, which is adapted to close with a floor at the gate, thus the bottom face of the bottom baffle 20 will in most cases be substantially flat.

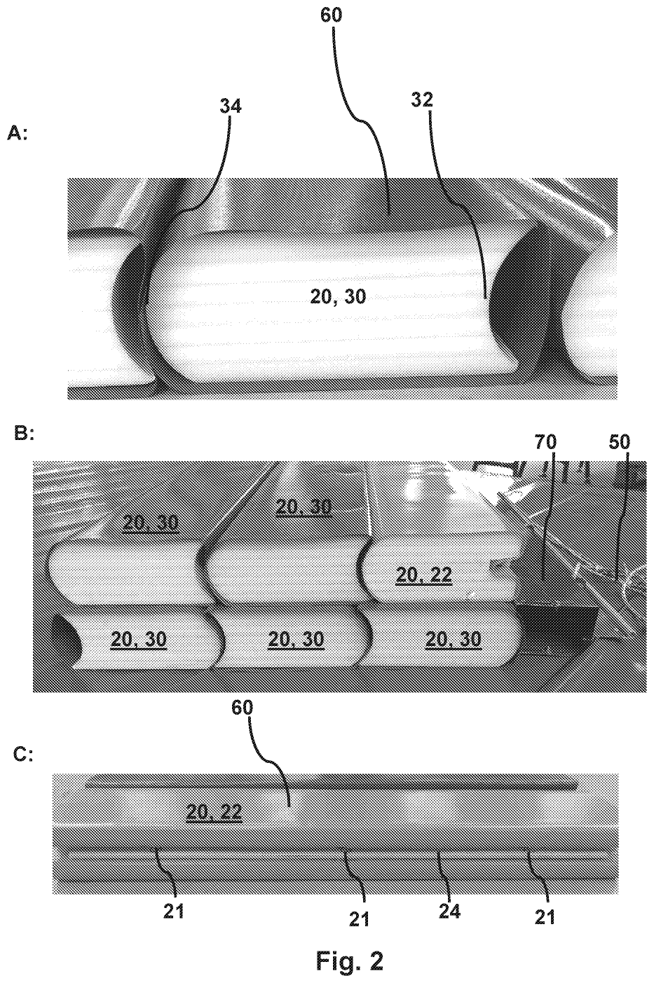

The flexible web 60 does not conform to the bottom face 32, when the intermediate baffles 30 are apart, this can be seen in FIG. 1B, however it is clearly shown in FIG. 2A. The result is a better connection between the baffles 20, when the baffles 20 are forced together as the flexible web 60 will have a biasing force directed to the baffle 20 below.

The door leaf 10 further comprises a biasing cassette 70. The general purpose of the biasing cassette 70 is to provide slack between the bottom baffle 22 and the biasing cassette 70, thereby allowing the door leaf 10 to be moved along curved paths.

The intermediate baffles 30I, . . . ,30V extend between the bottom baffle 20 and the biasing cassette 70.

The biasing cassette 70 comprises one or more cassette channels 72 in continuation of the common cord channels 40. The cassette channels 72 are shown with a dashed line in FIG. 1B, wherein the cassette channels 72 and the common cord channels 40 are slightly off-set because the baffles 20 and the biasing cassette 70 are not forced together.

The biasing cassette 70 have three friction elements 74 for frictionally gripping the one or more cords 50, such that the entire door leaf 10 can be forced into an insulating state (FIG. 1A) by pulling the cords 50. The door leaf 10 can be changed to an open state by adding more cord between the biasing cassette 70 and the bottom baffle 22.

The biasing cassette 70 further comprises a bottom part 76, a top part 78 and one or more biasing elements 80 (not shown) extending between the bottom part 76 and the top part 76. The biasing element is adapted for forcing the top part and the bottom part 76, 78 away from each other.

This will allow the door leaf 10 to provide slack to the cords 40 when the door leaf 10 is rolled together, the amount of slack is determined by the distance between the bottom part 76 and the top part 76 as well as the biasing element 80, the skilled person would by experiment be able to choose a design giving the necessary slack.

In this embodiment, the bottom part 76 and the top part 78 have U-shaped cross-sections facing each other and one part 76,78 being slideable within the other part 78,76.

The insulated door leaf 10 further comprises means for connecting with a drag leaf 90, the means are in this embodiment connected to the biasing cassette 70.

FIG. 2 illustrates an intermediate baffle 30 (FIG. 2A), a packed door leaf 10 (FIG. 2B) and a bottom baffle 22 (FIG. 2C).

FIG. 2A discloses the intermediate baffle 20, 30 being substantially formed by insulating material wrapped in a flexible web 60.

The insulating material comprises a bottom face 32 for facing the bottom baffle 22 and an opposite top face 34, wherein the bottom face 32 being concave and the top face 34 being convex.

The flexible web 60 does not conform to the bottom face 32, when the one or more intermediate baffles 30 are apart as this will increase the connection between two baffles 20 and thus increase the insulation efficiency.

The intermediate baffle 20, 30 comprises through-going baffle channels 21 which are not shown for forming part of not shown common cord channels 40.

FIG. 2B discloses the door leaf 10 in a packed state, wherein there is a slack from the cords 50 applied between the biasing cassette 70 and the bottom baffle 22, which al-lows the door leaf to be in packed state. This will greatly increase the ease transportation of the door leaf 10 which will decrease transportation costs.

FIG. 2C discloses the bottom baffle 22 having three through-going baffle channels 21, wherein cords 50 (not shown) are connected to a transverse bar 24.

The bottom baffle 22 being substantially formed by insulating material wrapped in a flexible web 60.

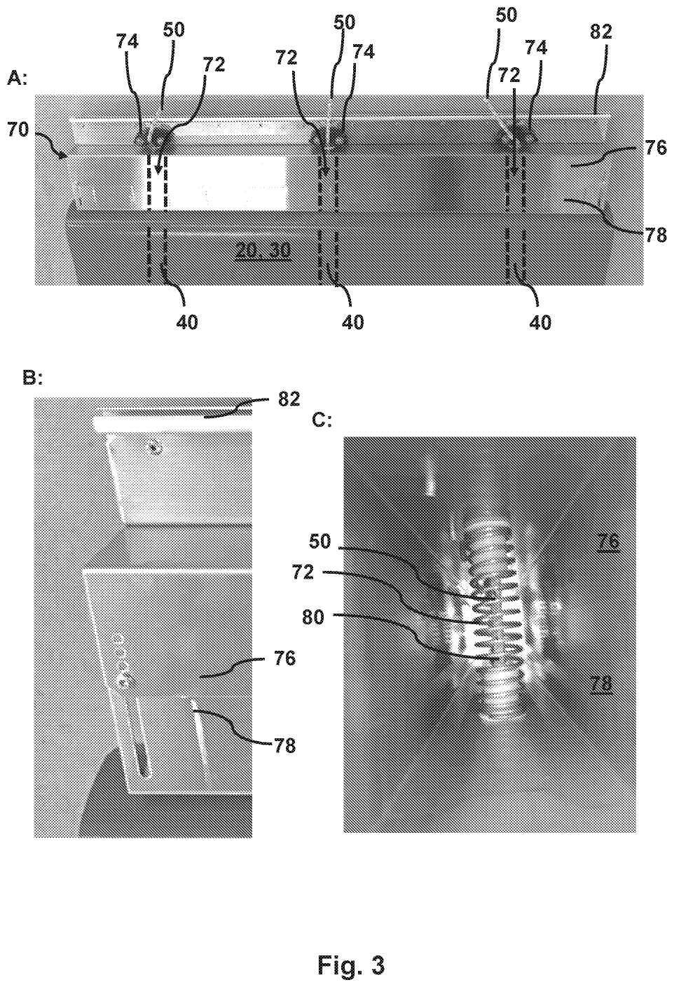

FIG. 3 illustrates a biasing cassette 70.

The biasing cassette 70 comprises one or more cassette channels 72 in adapted to be in continuation of one or more common cord channels 40. In the present case, there are three cassette channels 72 and three common cord channels 40, however there may be any other number.

The biasing cassette 70 has one or more friction elements 74 for frictionally gripping the one or more cords. Thereby, the length of the cords 50 between the friction elements 74 and a not shown bottom baffle 22 can be controlled.

The biasing cassette 70 further comprises a drag leaf engagement means 82 such that the biasing cassette 70 can be connected to a drag leaf 90 which will provide a uniform drag force when moving the door leaf 10. This is shown in greatest detail in FIG. 3B.

The biasing cassette 70 comprises a bottom part 76, a top part 78 and one or more biasing element 80 (see FIG. 3C) extending between the bottom part 76 and the top part 78 for forcing the top part and the bottom part 76, 78 away from each other.

The bottom part 76 and the top part 78 have U-shaped cross-sections facing each other and one part 76, 78 being slideable within the other part 78, 76.

In this embodiment the biasing elements 80 form the cassette channel 72 as it improves the stability of the biasing cassette 70.

In this embodiment the biasing elements 80 are springs.

The drag leaf engagement means 82 is a slit for receiving and holding a drag leaf 90.

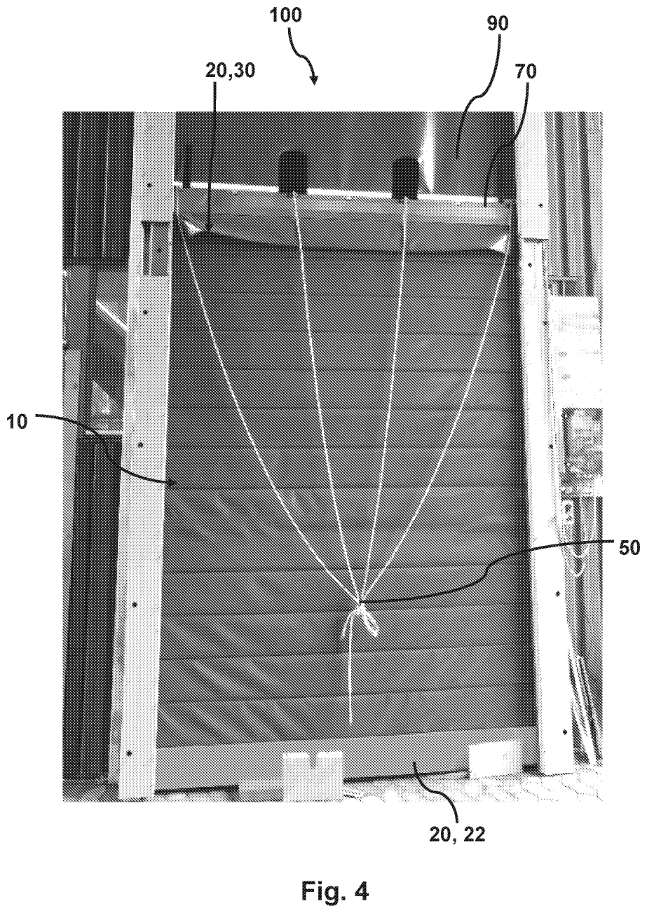

FIG. 4 illustrates a gate 100 comprising a door leaf 10 comprising baffles 20 comprising several intermediate baffles 30 between a bottom baffle 22 and a biasing cassette 70.

The shown gate 100 is a picture of a test gate and in real use the cords 50 will be significantly shorter.

The biasing cassette 70 comprises drag leaf engagement means 82 for receiving and holding a drag leaf 90. The drag leaf engagement means 82 may be a slit.

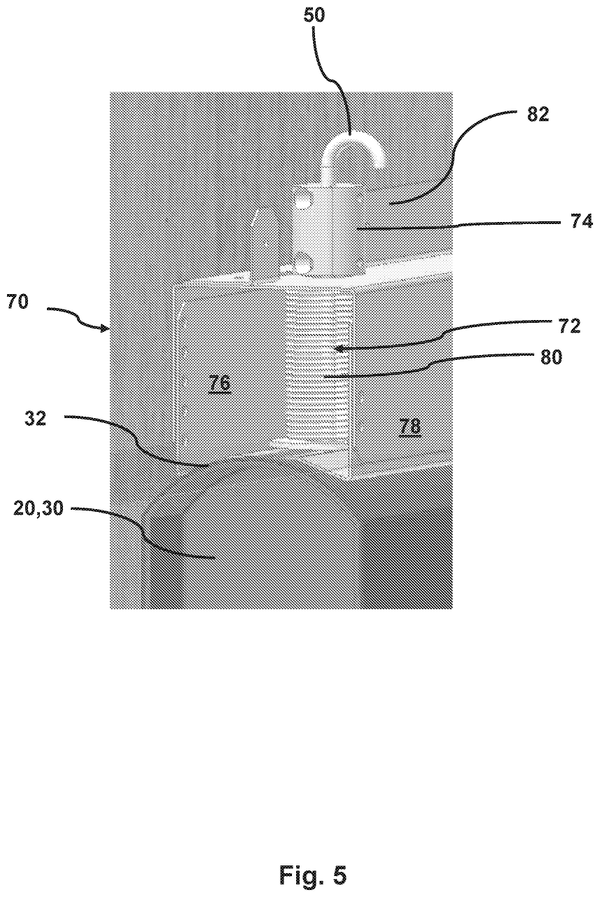

FIG. 5 illustrates a second embodiment of a biasing cassette 70.

The biasing cassette 70 comprises one or more cassette channels 72 in adapted to be in continuation of one or more common cord channels 40. In the present case, there are three cassette channels 72 and three common cord channels 40, however there may be any other number.

The biasing cassette 70 has one or more friction elements 74 for frictionally gripping the one or more cords. Thereby, the length of the cords 50 between the friction elements 74 and a not shown bottom baffle 22 can be controlled.

The biasing cassette 70 further comprises a drag leaf engagement means 82 such that the biasing cassette 70 can be connected to a drag leaf 90 which will provide a uniform drag force when moving the door leaf 10. This is shown in greatest detail in FIG. 3B.

The biasing cassette 70 comprises a bottom part 76, a top part 78 and one or more biasing elements 80 (see FIG. 3C) extending between the bottom part 76 and the top part 78 for forcing the top part and the bottom part 76, 78 away from each other.

The bottom part 76 and the top part 78 have U-shaped cross-sections facing each other and one part 76, 78 being slideable within the other part 78, 76.

In this embodiment, the biasing elements 80 form the cassette channel 72 as it improves the stability of the biasing cassette 70.

In this embodiment, the biasing elements 80 are springs.

The drag leaf engagement means 82 is a slit for receiving and holding a drag leaf 90.

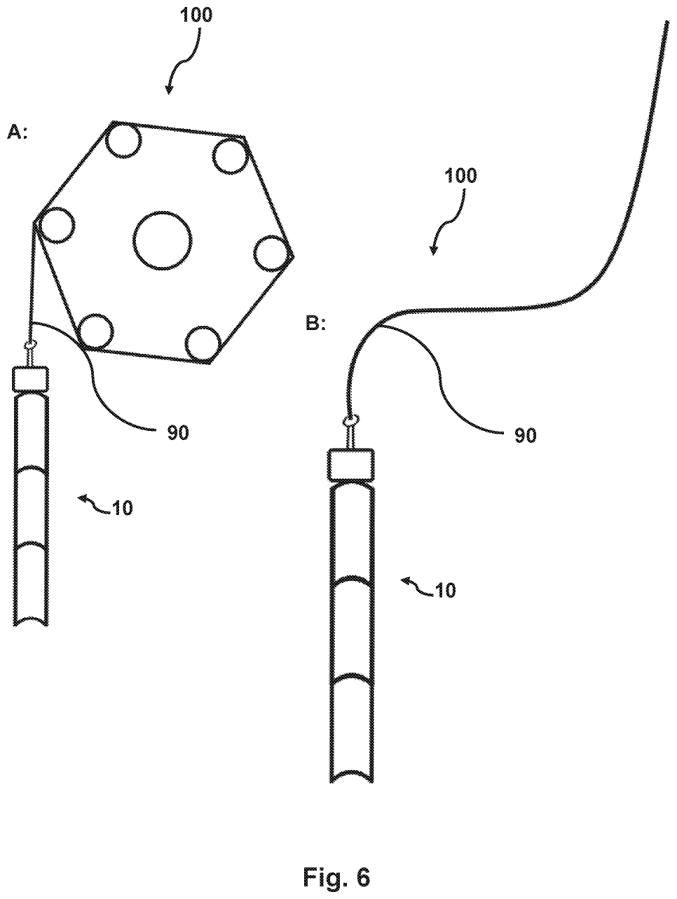

FIG. 6 illustrates two different embodiments of a gate 100 comprising a door leaf 10.

FIG. 6A discloses a roller gate 100.

FIG. 6B discloses a gate 100 in the form of a sectional door.

Both gates 100 require that the door leaf 10 is equipped with a biasing cassette 70 as the door leaf 10 requires slack during change in direction.

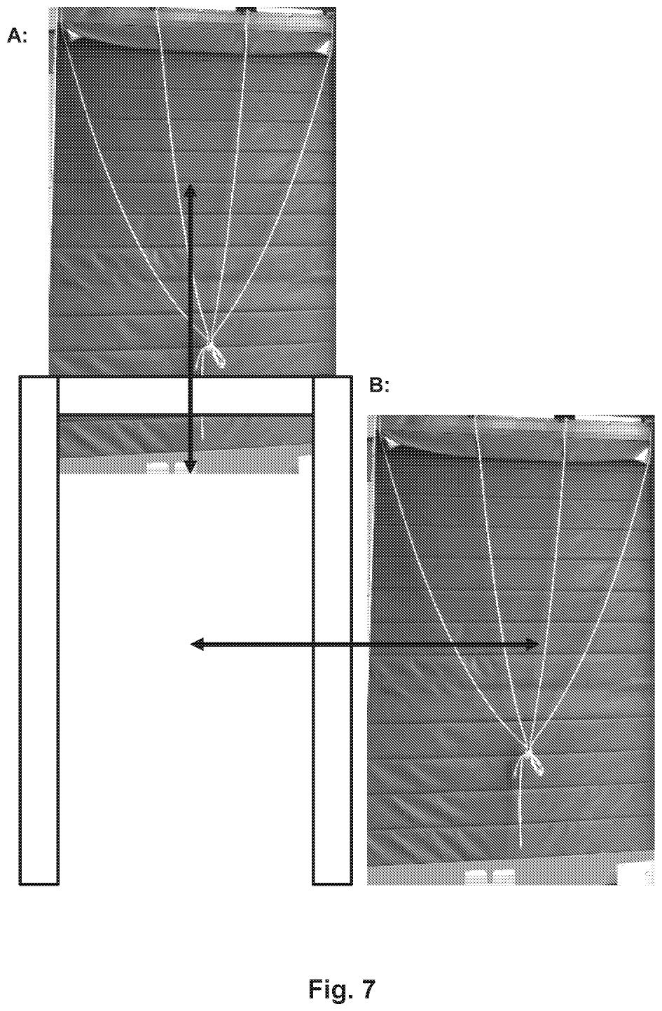

FIG. 7 illustrates two different embodiments of a gate comprising a door leaf.

FIG. 7A discloses a gate 100 which can move the door leaf 10 directly up and down. This type of gate 100 can work with a door leaf 10 as described without the biasing cassette 70 as there is no need for slack.

FIG. 7B discloses a gate 100 which can move the door leaf 10 directly side-to-side. This type of gate 100 can work with a door leaf 10 as described without the biasing cassette 70 as there is no need for slack.

1. An insulated door leaf for a gate the door leaf comprising:
a plurality of insulating baffles comprising a bottom baffle and one or more intermediate, the plurality of insulating baffles comprise baffle channels forming one or more common cord channels from the bottom baffle through the one or more intermediate baffles,
one or more cords extending from the bottom baffle through the one or more common cord channels of the plurality of insulating baffles where the one or more intermediate baffles comprise a bottom face facing the bottom baffle and an opposite top face; wherein the bottom face being concave and the top face being convex and wherein one or more intermediate baffles individually are wrapped in a flexible web, wherein the flexible web does not conform to the bottom face of the intermediate baffles, when the one or more intermediate baffles are apart.

2. The insulated door leaf according to claim 1, wherein at least two of the plurality of insulating baffles-PO) are separate units only interconnected by the one or more cords.

3-4. (canceled)

5. The insulated door leaf according to claim 1, wherein the insulated door leaf comprises a biasing cassette, wherein the one or more intermediate baffles are positioned between the bottom baffle and the biasing cassette,
the biasing cassette comprising one or more cassette channels in continuation of the one or more common cord channels.

6. The insulated door leaf according to claim 3, wherein the biasing cassette having one or more friction elements for frictionally gripping the one or more cords.

7. The insulated door leaf according to claim 5, wherein the biasing cassette comprises a bottom part, a top part and one or more biasing elements extending between the bottom part and the top part for forcing the top part and the bottom part away from each other.

8. The insulated door leaf according to claim 7, wherein the bottom part and the top part have U-shaped cross-sections facing each other and one part being slideable within the other part.

9. The insulated door leaf according to claim 1, wherein the insulated door leaf comprises means for connecting with a drag leaf.

10. An intermediate baffle comprising an insulating baffle adapted to engage with a bottom baffle via one or more cords extending from the bottom baffle through one or more common cord channels of the intermediate baffle, the intermediate baffle comprising a bottom face to face the bottom baffle and an opposite top face; wherein the bottom face being concave and the top face being convex and wherein the intermediate baffle is wrapped in a flexible web, wherein the flexible web does not conform to the bottom face.

11. (canceled)

12. A gate (100) comprising an insulated door leaf (10) according to claim 1.

13. An insulated door leaf comprising:
an intermediate baffle comprising an insulating baffle adapted to engage with a bottom baffle via one or more cords extending from the bottom baffle through one or more common cord channels of the intermediate baffle, the intermediate baffle comprising a bottom face to face the bottom baffle and an opposite top face; wherein the bottom face being concave and the top face being convex and wherein the intermediate baffle is wrapped in a flexible web, wherein the flexible web does not conform to the bottom face.
